(19) United States
(12) Patent Application Publication
(10) Pub. No.: US 2008/0003412 A1
(43) Pub. Date: Jan. 3, 2008

(54) COVER FOR A MOBILE DEVICE AND METHOD FOR MAKING THE COVER

(75) Inventors: JONG-YI SU, Shindian (TW); HUI-TAO YE, Shenzhen (CN); YI-QIANG XU, Shenzhen (CN); ZHEN-YUAN ZHAI, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/616,831

(22) Filed: Dec. 27, 2006

(30) Foreign Application Priority Data
Jun. 30, 2006 (CN) 200610061429.7

(51) Int. Cl. B41M 5/00

(52) U.S. Cl. 428/195.1

(57) ABSTRACT

A cover for a mobile device includes a substrate with a surface including a patterned surface portion and a non-patterned surface portion. An ink coating is formed on the patterned surface portion of the substrate. A metal coating system is electroplated on the non-patterned surface portion of the substrate. The ink coating is recessed relative to the metal coating system.

### BACKGROUND OF THE INVENTION

1. Field of the Invention

The present invention relates generally to covers for mobile devices and, more particularly, to an electroplated cover for a mobile device and to a method for making the cover.

2. Discussion of the Related Art

Electroplating is an attractive and effective process for improving corrosion resistance and metallic appearance of covers. Many covers for mobile devices are processed to form plated metal coatings on surfaces thereof via electronic plating.

Designs as such picture or patterns are typically made on the cover by printing ink on the covers. However, the ink has poor adhesion to the plated metal coatings, thus the ink is liable to be worn away.

Therefore, a cover for a mobile device is desired in order to overcome the above-described shortcomings.

### SUMMARY

In one embodiment thereof, a cover for a mobile device is provided. The cover for a mobile device includes a substrate with a surface including a patterned surface portion and a non-patterned surface portion. An ink coating is formed on the patterned surface portion of the substrate. A metal coating system is electroplated on the non-patterned surface portion of the substrate. The ink coating is recessed relative to the metal coating system.

Other advantages and novel features will become more apparent from the following detailed description of preferred embodiments when taken in conjunction with the accompanying drawings.

### BRIEF DESCRIPTION OF THE DRAWINGS

Many aspects of the cover for a mobile device and the method for making the cover can be better understood with reference to the following drawing. The components in the drawing are not necessarily drawn to scale, the emphasis instead being placed upon clearly illustrating the principles of the cover for a mobile device and the method for making the cover. Moreover, in the drawing like reference numerals designate corresponding parts throughout the several views.

FIG. 1 is a flow chart of a method for making a cover in accordance with a preferred embodiment of the present invention.

### DETAILED DESCRIPTION OF THE PREFERRED EMBODIMENTS

In a preferred embodiment, a cover is provided with a surface including a patterned surface portion and a non-patterned surface portion. The patterned surface portion has an ink coating formed thereon to form marks or figures. The non-patterned surface portion has a plated metal coating system formed thereon. The ink coating is recessed relative to the metal coating system.

The cover may be made of material selected from the group consisting of acrylonitrile butadiene styrene (ABS), polymethyl methacrylate (PMMA), and polycarbonate (PC). The cover also may be made of metal, such as steel, titanium, aluminum, and their alloys.

The ink coating on the patterned surface may be applied by printing process, preferably being applied by screen printing, so as to display designs such as patterns, pictures and writing. The ink should preferably involve an acid-resistant, alkali-resistant and non-conductive resin system.

The metal coating system includes a copper coating, a nickel coating, and a chromium coating. The copper coating, the nickel coating, and the chromium coating are electroplated on the non-patterned surface portion of the cover in series. The metal coating system has a thickness approximately 0.03 mm larger than that of the ink coating.

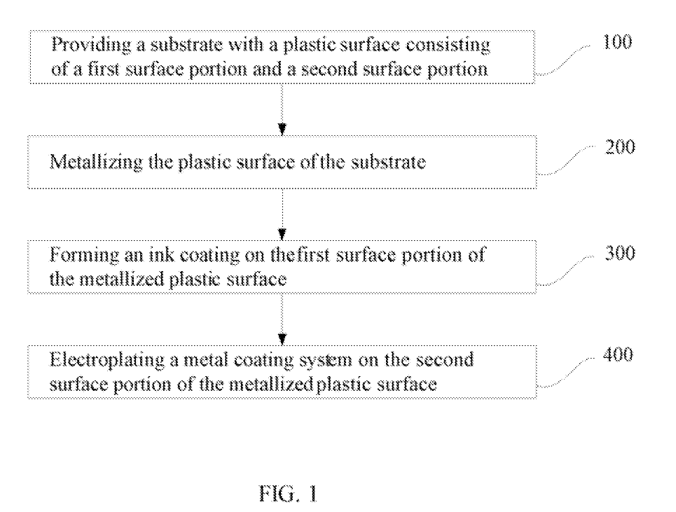

Referring to FIG. 1, a method for making the cover includes steps 100 to 400. In step 100, a substrate is provided with a plastic surface including a patterned surface portion and a non-patterned surface portion. In step 200, the plastic surface of the substrate is metallized. In step 300, an ink coating is formed on the patterned surface portion of the metallized plastic surface. In step 400, a metal coating system is electroplated onto the non-patterned surface portion of the metallized plastic surface so that the ink coating is recessed relative to the metal coating system. Detailed description about the steps is as following:

Firstly, the substrate is provided. The substrate is made of material selected from the group consisting of acrylonitrile butadiene styrene (ABS), polymethyl methacrylate (PMMA), and polycarbonate (PC).

Secondly, the plastic surface of the substrate is metallized via physical vacuum deposition or wet chemical deposition. In physical vacuum deposition, the plastic surface of the substrate to be metallized is treated in a vacuum chamber containing metal atoms or ions to form a conductive metal film. In wet chemical deposition, the plastic surface of the substrate to be metallized is etched so that the plastic surface is roughened. The etching of the substrate allows an activating layer in a subsequent process to be attached on to the roughened plastic surface. The etching process may be carried out, for example, in a chromic acid, chromosulfuric acid, or potassium permanganate etching solution. It is, of course, to be understood that the etching process also can be carried out in a plasma chamber. An associated cleaning step is then carried out for cleaning the etched substrate. Subsequently, the plastic surface is immersed into an activating solution containing hydrochloric acid, polyamide acid, and noble metal salt, so as to form an activating metal layer hooked on to the roughened plastic surface. After the activation of the plastic surface, the substrate is rinsed and then metallized with chemical copper plating in a copper electrolyte containing sulfuric acid. It is, of course, to be understood that the substrate also can be nickel plated in a nickel electrolyte. Thus, the substrate with a metallized plastic surface is obtained.

Thirdly, the ink coating is formed on the patterned surface portion of the metallized plastic surface by screen printing, so that the patterned surface portion of the metallized substrate can be prevented from being coated in a subsequent deposition process. The ink preferably should involve an acid-resistant, alkali-resistant and non-conductive resin system.

After the ink coating being applied on the patterned surface portion of the metallized plastic surface, a metal coating system is electroplated on to a non-patterned surface portion of the metallized plastic surface. The metal coating system includes a copper coating, a nickel coating, and a chromium coating. In a first step of forming the metal coating system, the metallized substrate is immersed in a copper electrolyte containing copper sulfate, copper cyanide or copper pyrophosphate. A copper coating is then electroplated onto the non-patterned surface portion of the metallized plastic surface, using the metallized substrate as a cathode and a copper block as an anode. In a second step of forming the metal coating system, a nickel coating is formed on the copper coating. The process of the nickel coating is carried out in a nickel electrolyte containing nickel sulfate, nickel chloride, and boric acid, using the metallized substrate as a cathode and a nickel block as an anode. In a third step of forming the metal coating system, a chrome coating is electroplated onto the nickel coating in a chrome electrolyte, using the metallized substrate as a cathode and a chrome block as an anode.

The thickness of the metal coating system increases as the copper electroplating, the nickel electroplating, or the chrome eletroplating proceeds, thus the metal coating system with a desired thickness approximately 0.03 mm larger than that of the ink coating can be obtained by controlling the length of time over which the copper electroplating, the nickel electroplating, and the chrome electroplating take place. The ink coating is a non-conductive resin system, so that the patterned surface portion of the metallized substrate can be prevented from being coated in the electroplating processes. Therefore, the ink coating is recessed relative to the metal coating system.

It should be understood that, in a case of that the substrate is made of metal, such as steel, titanium, aluminum, and their alloys, the method for making the cover may not include the step of metallization of the surface of the substrate. The ink coating is formed on the patterned surface portion of the substrate. The copper coating, the nickel coating, and the chromium coating are electroplated on the non-patterned surface portion of the substrate in turn, so that the ink coating is recessed relative to the metal coating system, and the metal coating system has a thickness approximately 0.03 mm larger than that of the ink coating.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cover for a mobile device, comprising:
a substrate having a surface including at least a patterned surface portion and at least a non-patterned surface portion;
an ink coating formed on the patterned surface portion of the substrate; and
a metal coating system electroplated on the non-patterned surface portion of the substrate;
wherein the ink coating is recessed relative to the metal coating system.

2. The cover as claimed in claim 1, wherein the substrate is made of plastic selected from the group consisting of acrylonitrile butadiene styrene, polymethyl methacrylate, and polycarbonate.

3. The cover as claimed in claim 1, wherein the substrate is made of metal selected from the group consisting of steel, titanium, aluminum, and alloys thereof.

4. The cover as claimed in claim 2, wherein the metal coating system includes a copper coating, a nickel coating, and a chrome coating overlain on the non-patterned surface portion in turn.

5. The cover as claimed in claim 1, wherein the ink coating formed on the patterned surface portion of the substrate is applied by printing process, the ink coating involves an acid-resistant, alkali-resistant and non-conductive resin system.

6. The cover as claimed in claim 1, wherein the metal coating system has a thickness approximately 0.03 mm larger than that of the ink coating.

7. A method for making a cover for a mobile device, comprising the steps of:
providing a substrate having a surface including at least a patterned surface portion and at least a non-patterned surface portion;
forming an ink coating on the patterned surface portion of the substrate; and
electroplating a metal coating system on the non-patterned surface portion of the substrate;
wherein the ink coating is recessed relative to the metal coating system.

8. The method for making the cover as claimed in claim 7, wherein the substrate is made of plastic selected from the group consisting of acrylonitrile butadiene styrene, polymethyl methacrylate, and polycarbonate.

9. The method for making the cover as claimed in claim 8, wherein the substrate is metallized before forming the ink coating.

10. The method for making the cover as claimed in claim 9, wherein the metallization of the substrate is carried out via physical vacuum deposition to form a conductive metal film on the substrate.

11. The method for making the cover as claimed in claim 9, wherein the metallization of the substrate is carried out via wet chemical deposition, including steps of: roughening the surface of the substrate, activating the surface of the substrate, and chemically depositing a conductive metal film on the surface of the substrate.

12. The method for making the cover as claimed in claim 7, wherein the metal coating system includes a copper coating, a nickel coating, and a chrome coating overlain on the non-patterned surface portion in turn.

13. The method for making the cover as claimed in claim 7, wherein the ink coating formed on the patterned surface portion of the substrate is applied by printing.

14. The method for making the cover as claimed in claim 13, wherein the ink coating involves an acid-resistant, alkali-resistant and non-conductive resin system.

15. The method for making the cover as claimed in claim 7, wherein the substrate is made of metal selected from the group consisting of steel, titanium, aluminum, and alloys thereof.

16. The method for making the cover as claimed in claim 7, wherein the metal coating system has a thickness approximately 0.03 mm larger than that of the ink coating.
